(19) United States
(12) Patent Application Publication
(10) Pub. No.: US 2005/0266124 A1
(43) Pub. Date: Dec. 1, 2005

(54) Storage and transportation tote

(75) Inventor: Jerald R. Stoker, Clearbrook, MN (US)

Correspondence Address: NIKOLAI & MERSEREAU, P.A., 900 SECOND AVENUE SOUTH, SUITE 820, MINNEAPOLIS, MN, 55402, US

(73) Assignee: Bee Excellent, Clearbrook, MN (US)

(21) Appl. No.: 11/135,811

(22) Filed: May 24, 2005

Related U.S. Application Data
(60) Provisional application No. 60/574,472, filed on May 25, 2004.

(51) Int. Cl. C12C 1/027

(52) U.S. Cl. 426/106

(57) ABSTRACT

A storage and transportation tote which is used to store and transport food items like honey. The tote saves space and is easy to manipulate because of its shape. Generally the device is a stainless steel box with feet that are shaped to allow easy stacking with the top of the structure. The device has a removable top surface with a cylindrical access feature in that top surface. It additionally is easily movable by a forklift or pallet jack because of the specially shaped tubular feet of rectangular cross-section joined to the lower surface of the tote container.

### BACKGROUND OF THE INVENTION

Cross Reference to Co-Pending Provisional Application This application claims the benefit of Provisional Application No. 60/574,472, filed May 25, 2004, the entire content of which is hereby incorporated by reference in this application.

I. Field of the Invention:

This invention relates to storage containers, and more particularly to a storage and transportation tote that can efficiently store sizable quantities of food or other material.

II. Discussion of the Prior Art:

Currently there are many storage containers and devices for keeping food items fresh and movable. Fifty five gallon steel drums are frequently used to store bulk foods like honey, for example. However, there are some problems with such drum or barrel storage. Because cylindrical shapes do not closely match surfaces with other cylindrical shapes a great potential for lost storage space exists when multiple drums are placed next to one another. Also, these drums often can only be safely stacked to a limited height.

In general, drums and barrels are somewhat difficult to manipulate with a fork lift and usually require some manual labor to put in a desired location. A great amount of time and energy is wasted on filling, dumping, moving, and handling them as well. Also, many storage containers are not sanitary or readily suitable for maintaining high quality food because they are susceptible to chipped paint, rust or other contaminating elements.

Also, other existing containers for bulk foods consist of a plastic tank with a metal cage supporting the tank. These are primarily used by farm chemical manufacturers and are generally not designed to be rotated. Further, these designs are not suitable for storage and preparation of products like honey as the plastic tanks can not handle the heat of the ovens commonly used to liquefy or render honey less viscous.

Thus, a container is needed which efficiently fits with other containers to save space, that is readily stackable, that provides easy access for fork lift tines and pallet jacks, that saves time and manual labor when filling, emptying, moving and handling containers, and is made from stainless steel or other sanitary material that can withstand high temperatures.

### SUMMARY OF THE INVENTION

A storage and transportation tote is used to store and move food materials like honey, for example, is generally a box shaped stainless steel structure with four sidewalls, a top surface, and a bottom surface. The box is raised slightly off the ground by short tubular feet of rectangular cross-section along the two opposed sides proximate the bottom of the tote. The tote structure has a removable top that contains a raised cylindrical collar surrounding an opening for access to the inside of the tote. Also, there is a removable lid which cooperates with the cylindrical collar to seal the container. The cylindrical collar also uses its shape to align and stabilize additional stacked totes. A stacked tote has its movement constrained by the raised collar of the tote below it. The collar falls between the tubular feet of the stacked tote to inhibit lateral movement of a stacked tote. In this way a stable, safe, and structurally sound stack of storage units can be achieved. The tubular feet are dimensioned and spaced to allow the forks of a fork lift or pallet jack to fit into or between adjacent feet.

### OBJECTS OF THE INVENTION

It is an object of the invention to provide a space saving food storage container.

It is than an object of the invention to provide a food storage container which has an increased capacity for stacking.

It is a further object of the invention to provide a food storage container which has four way access for a fork lift and two way access for a pallet jack.

It is yet another object of the invention to provide a food storage container that results in savings by improved filling, emptying, moving, and handling capability with a minimum of manual labor.

It is still another object of the invention to provide a food storage container which is sanitary and is not susceptible to rust or paint contamination.

It is a still further object of the invention to provide a food storage container that can withstand elevated temperatures.

Other objects, advantages and novel features of the present invention will become apparent from the following detailed description of the invention when considered in conjunction with the accompanying drawing.

### DESCRIPTION OF THE DRAWINGS

FIG. 1 is a perspective view of the storage and transportation tote;

FIG. 2 is a bottom view of the present invention;

FIG. 3 is a top view of the present invention; and

FIG. 4 is a cross-sectional view of the attachment of the top and front surfaces of the present invention.

### DESCRIPTION OF THE PREFERRED EMBODIMENT

The present invention represents broadly applicable improvements for storage and transportation totes. The embodiments described herein are intended to be taken as representative of those in which the invention may be incorporated and are not intended to be limiting.

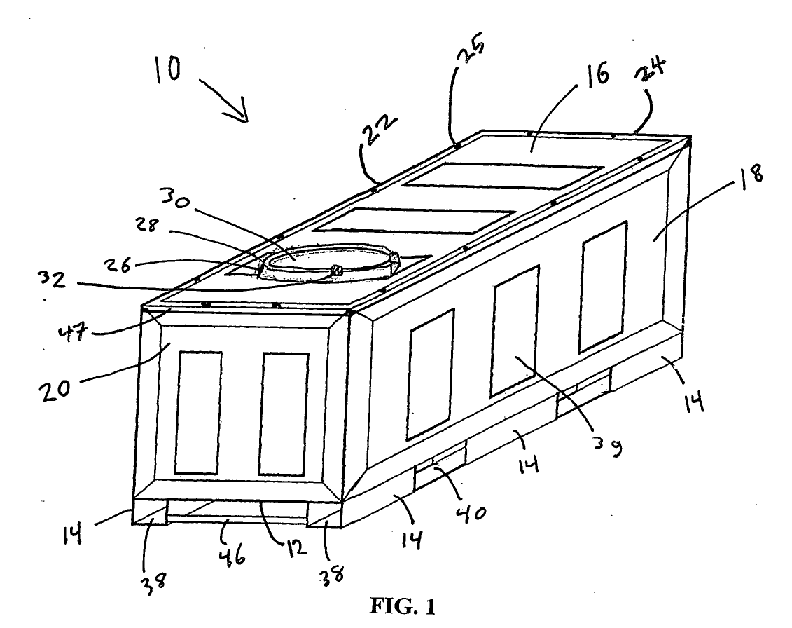

FIG. 1 shows a perspective view of the food storage and transportation tote. The system generally comprises a box shaped stainless steel structure 10. Without limitation, the approximate outside dimensions may be about are 35 inches high by 30 inches wide by 48 inches long. With these dimensions, the tote has an approximate capacity 166 US gallons, weighs about 240 lbs when empty and is made of food grade type SUS 304 stainless steel.

This type of tote design is especially well-suited for storage of honey. These dimensions allow 2000 pounds of honey to be stored in a single tote. This is the same amount of honey as would have to be stored in three 55 gallon steel drums, but the tote of the present invention only requires the space needed for two of such drums.

The box 10 does not sit on its bottom surface 12 of the box, but rather is raised slightly off the ground by relatively short tubular feet 14. These feet 14 are rectangular in cross-section and are welded or otherwise attached to the lower surface 12 of the tote generally along the lower edges of the two sides 18 and 22 and extend from corner to corner.

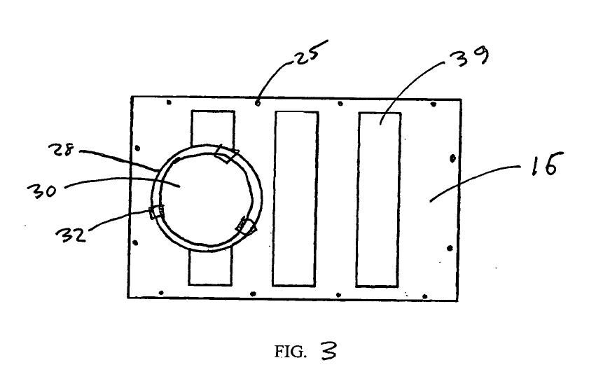

The tote structure 10 has a top cover 16 and mutually perpendicular surrounding side walls 18, 20, 22, and 24. The top cover 16 is removable from these surrounding walls as its four edges are turned down to fit over the top edges of the walls 18, 20, 22, and 24 in a fashion similar to the cover of a shoebox. There are a number of locations around the perimeter of top surface 16 which allow it to be held in place with fasteners 25, such as bolts, screws, etc. For example, such fasteners may be screws which are tightened against spring loaded nuts located in pockets within the top perimeter of the tote walls. The ability to remove the top cover 16 is useful for loading and unloading the container's contents when necessary. Located near one end of this surface 16 is a raised cylindrical collar 26 that surrounds a circular opening through which access to the inside of the container can be accomplished without having to totally remove the top surface 16 from the tote. The cylindrical collar 26 flares out to form an upper flange 28 extending around the top of the cylindrical collar 26. There is a removable cap 30 which fits within the cylindrical lip 28 and is capable of providing a water-tight seal similar to that of a conventional paint can to the inside of the container. Fasteners 32 additionally connect between the cap 30 and upper lip 28 of the collar 26 to aid in the sealing process. FIG. 3 provides a more detailed view of this top surface 16 and its features.

The cylindrical collar 26 protrudes from the plane of top surface 16 such that its features aid in the stacking of similar totes. A tote stacked upon another tote generally is aligned and has its lateral movement constrained by the raised cylindrical collar 26 of the lower tote residing between the confines of the feet 14 of the upper tote. In this way a stable, safe, and structurally sound stack of storage units can be achieved. The totes may be stacked 5 units high when full and to a much greater height when empty. This is estimated to provide a 20% space savings over use of 55 gallon drums and can greatly exceed the maximum empty barrel height of about five barrels tall.

The walls 18, 20, 22, and 24, the top surface 16, and the bottom surface 12 of the containers are preferably made of integrally formed panels of stainless steel using a stamping and bending operation. These surfaces additionally contain a series of slightly recessed, aligned, rectangular panels 39 to provide extra rigidity and strength.

The tubular feet 14 provide fork pockets 38 located below the bottom 12 of the tote. These fork pockets 38 run the length of the tote and have side openings 40 below end walls 20 and 24. The fork pockets 38 are intended to hold the tote on the forks of a rotating head fork lift, allowing inversion and suspension of the tote by a fork lift vehicle. The tote is designed to be rotated from 0 to 180 degrees, i.e. from upright to upside down, to dump or empty the tote's contents. Because of the tote's integrated stainless steel design totes may be placed upside down in ovens as well.

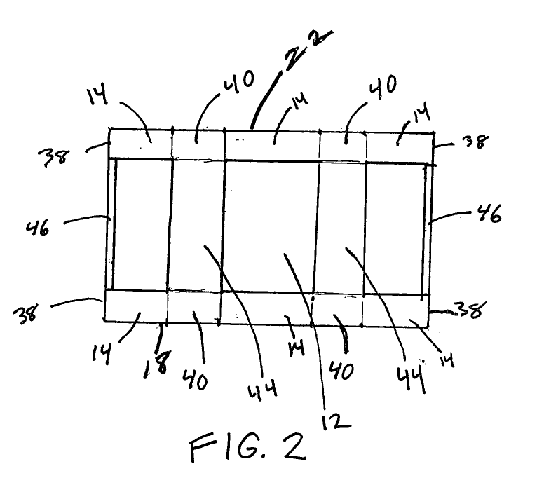

Now referring to FIG. 2, a bottom view of the present invention is disclosed. FIG. 2 is not to the same scale as FIG. 1. The feet 14, used to elevate the tote from the ground, are seen extending along the sides of the tote. These hollow rectangular members 14 have openings at their ends, known as fork pockets 38, but each additionally have two openings, as at 40, which split the feet 14 into three sections. These openings 40 are found at equivalent distances from the center of the short feet 14. These openings 40 provide fork lift access for entry from the side of the tote. Inside these openings 40 are found fork “J” pockets 44 which are joined to the bottom surface 20 of the tote and extend between the feet 14 on the sides of the tote. The pockets 44 have a cross-section shaped like an inverted “J”, where one side of these members extends lower than the other side. The passageway provided by these pockets is useful for raising the tote with a fork lift or pallet jack.

Also seen in FIG. 2 are two reinforcement pipes 46. These pipes 46 are extend transversely across the ends 20 and 24 of the tote between the feet 14. These pipes are designed to provide further support and structural stability to the feet 14 and overall tote design.

The tote design is particularly easy to move and transport. It has four way access for fork lifts and two way access for a pallet jack. This eliminates the need for a manual barrel cart that would be required for barrel storage. Overall, it is estimated that the tote provides a 66% savings over typical barrel storage in filling, dumping, moving and handling with no manual labor involved.

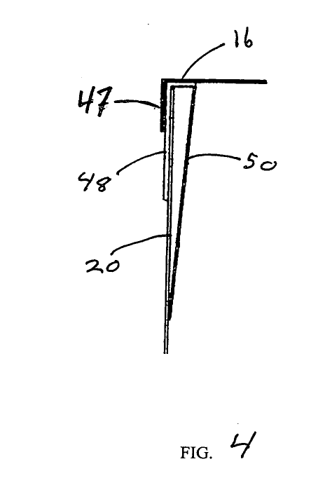

FIG. 4 discloses a detailed cross-sectional view of the interconnection and attachment of the side and top surfaces of the present invention. Top surface 16 is seen with a 90 degree angle forming a downward projecting lip 47. Inside this lip is a reinforcing angle 48. This angle bar is also bent forming a 90 degree angle and is used for structural stability in this and similar joined surfaces throughout the tote of the present invention. Inside the bar 48 is the stainless steel wall 20. Last, within the inside surface of wall 20 is a stainless steel stiffener bar 50 which projects inward from the wall 20 until it reaches the edge of the reinforcement bar 48, just below the top surface 16. The stiffener bar providing further support and stability of the upper perimeter of the tote walls.

The operation of the storage and transportation tote is as follows. First, an operator loads the product, e.g., honey, into the tote container through the opening beneath the cap 30 in the raised cylindrical structure. Once filled, the cap 30 is fitted over the circular opening and is secured with fasteners 32. The tote is then ready to be shipped to a processing plant/final customer. Upon arrival at a processing plant, totes are removed from trucks with a standard fork lift, or pallet jack. The totes are then stacked and stored or taken directly to ovens. Next, a tote is moved from storage to an oven, the lid is removed, and a fork lift with the ability to rotate objects 180 degrees inserts its forks into fork pockets of the tote. The tote is then lifted, inverted and placed in the oven. If the product (ex. honey) is in granulated form, it melts and releases from the sides and bottom of the tote to drop and slide out of the tote in block form. Alternatively, if the product was in liquid form, the top surface would be retained on the tote, the cover 30 removed and tote inverted to pour the contents in a desired location.

There are wide ranging fields of technology in which an effective an efficient container of this design could be used. Although this design is particularly well-suited for storage of honey or other food items, its use is not limited to storage of only these materials.

Obviously, many modifications and variations of the present invention are possible in light of the above teachings. It is therefore to be understood that, within the scope of the appended claims, the invention may be practiced otherwise than as specifically described.

This invention has been defined herein in considerable detail in order to comply with the Patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

1. A storage and transportation tote comprising:
a box-shaped stainless steel housing having a bottom and four mutually perpendicular side walls;
a plurality of tubular support members of rectangular cross-section welded to the bottom of the housing; and
a removable top panel on the housing having a cylindrical protrusion surrounding a circular access opening, in which a removable cover resides.

2. The storage and transportation tote as in claim 1 wherein the stainless steel housing has planar wall surfaces with rectangular recessed planar panels offset from the planar wall surfaces.

3. The storage and transportation tote as in claim 2 wherein the box-shape of the tote allows plural totes to be stacked.

4. The storage and transportation tote as in claim 3 wherein the tote is adapted to transport and store honey.

5. The storage and transportation tote as in claim 1 wherein the tubular support members are positioned to afford four-way access for a forklift and two-way access for a pallet jack.

6. The storage and transportation tote as in claim 4 wherein the housing is adapted to be heated to an elevated temperature sufficient too allow granulated honey placed in the tote to melt and release from the side walls and bottom of the housing.

7. The storage and transportation tote as in claim 6 wherein with the top panel removed the granulated honey slides out of the housing in block form after heating and inversion of the tote.

8. The storage and transportation tote as in claim 1 wherein the housing with the top panel in place form an airtight seal.

9. The storage and transportation tote as in claim 1 wherein honey may be deposited into the tote through the circular access opening in the top panel when said cover is removed.

10. The storage and transportation tote as in claim 1 wherein a plurality of bar members connect the support members.

11. The storage and transportation tote as in claim 1 wherein the tote is adapted to be rotated from upright to upside down using a forklift having a rotatable fork assembly engaged within the support members.

12. A storage and transportation tote comprising:
a parallelepiped shaped container;
a plurality of support members attached to a bottom surface of the container and sized to receive the arms of a forklift or pallet jack; and
a removable cover making up the top surface of the parallelepiped shaped container.

13. The storage and transportation tote as in claim 12 wherein the tote is adapted to transport and store honey.

14. The storage and transportation tote as in claim 13 wherein granulated honey can be transformed from a solid form into a liquid form within the container upon heating.

15. The storage and transportation tote as in claim 12 wherein the container is watertight when the removable cover is in place and equipped with a closed lid.

16. The storage and transportation tote as in claim 15 wherein the container is made of stainless steel.

17. A storage and transportation tote comprising:
a watertight stainless steel container adapted to store honey;
attachment members feature welded to the exterior of the container adapted to be engaged by a forklift or jack pallet; and
a removable lid panel on the container having a passageway formed therein for receiving a product therethrough.

18. The storage and transportation tote as in claim 17 wherein the tote may be rotated from an upright to an upside down orientation using the attachment members.
